(19) United States
(12) Patent Application Publication
(10) Pub. No.: US 2009/0165315 A1
(43) Pub. Date: Jul. 2, 2009

(54) Wall Hanging Aid

(76) Inventor: Jared Rabin, Irvine, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 12/123,977

(22) Filed: May 20, 2008

Related U.S. Application Data
(60) Provisional application No. 61/017,773, filed on Dec. 30, 2007.

(51) Int. Cl. G01B 3/00; A47G 1/16

(52) U.S. Cl. 33/485; 33/451; 33/613

(57) ABSTRACT

An adjustable picture and wall hanging device comprising an elongated strap having thereon a pair of spaced sliders, each slider having a point thereon to enable a spot to be marked on a wall, and a level centrally mounted on the strap for facilitating leveling of the device so that the item to be mounted will be level. This device enables pictures and other items to be hung on a wall in a simple, quick and easy manner.

### CROSS-REFERENCE TO RELATED APPLICATIONS

This application claims priority to U.S. Provisional Application Ser. No. 61/017,773, filed Dec. 30, 2007, and is incorporated herewith in its entirety.

### BACKGROUND OF THE INVENTION

Hanging pictures and other items on a wall or the like can be simple or complicated. When one hook is used, it is a relatively simple matter to position it accurately so that the picture will hang properly. On the other hand, where two or more spaced hooks are used, there can be difficulty setting the spacing and particularly making sure they are at the same height so that the picture will be level. If one of the two hooks is either higher or lower than the other then it is apparent that the picture will hang at an angle.

The purpose of the present invention is to provide a simple device to mark spaced anchor points evenly level.

Accordingly, a principal purpose of the present invention is to provide an improved wall hanging aid.

### BRIEF DESCRIPTION OF THE DRAWINGS

These and other features and objects of the invention will become better understood for consideration of the following description and drawings wherein

FIG. 1 is a top view of the hanging aid, and

FIG. 2 is a side view thereof.

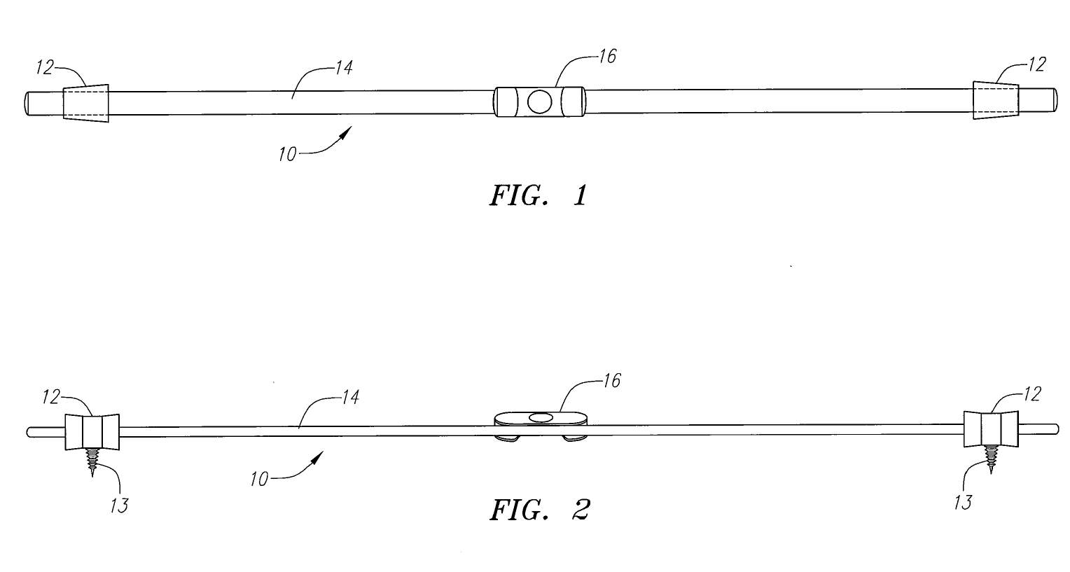

### DETAILED DESCRIPTION OF THE INVENTION

The present invention relates to an adjustable picture and wall hanging device to mark hanging anchor points on a wall level. This device can be made of any material not limited to, but including metal, plastic or the like so it can be folded or rolled up for storage. This device 10 has two sliders 12 with points 13 that can be slid to adjust to align the anchor hanging points. These sliders are moved along a flexible strap 14. The adjustable points 13 are used to make puncture dimples into the wall. The sliders can lock into place by friction so the spacing thereof is not altered before the puncture dimples can be made. This device has a built-in level 16 so that the puncture dimples can be leveled without one being higher or lower than the other. Slight pressure is applied to the sliders 12 against the wall so that the two puncture dimple marks are made into the wall by the points 13.

The first step is to align the two sliders 12 to the center of the anchor hanging points of the item to be hanged. The second is to lift the device 10 to the desired location. Third is to level with the built-in level 16 so the measured adjustable points are level. Fourth is to apply a small amount of pressure to the sliders so that small puncture dimples are made into the wall by the points 13. The last step is to place the desired anchors into the premeasured and leveled puncture dimple marks.

This device can also be constructed without the level to just measure anchor spacing. The adjustability of this device can be constructed with the two sliding pieces or with a series of collapsible pieces that are fit into each other. This device can also be constructed with a piece of cable, rope or other non-rigid material. This device preferably uses a bubble level, but can also be made with a laser level to ensure the puncture holes are level on the wall. The device has the two points 13 that puncture two holes into the wall, but the same device could utilize a marker, chalk, pencil, pen or paint marker to indicate the two places the anchors should be set.

Various changes, modifications, variations, and other uses and applications of the subject invention will, however, become apparent to those skilled in the art after considering this specification together with the accompanying drawings and claims. All such changes, modifications, variations, and other uses of the applications which do not depart from the spirit and scope of the invention are deemed to be covered by the invention, which is limited only by the claims which follow.

1. A picture and/or wall hanging device to mark hanging anchor points level comprising:
an elongated flexible strap,
two sliders mounted spaced apart on the strap having points and being adjustable to align to the anchor hanging points desired, the sliding points are fixedly adjustable on the strap so as to retain the selected positions, and
a level disposed approximately in the middle of the strap to enable adequate leveling of the mounting aid devices.

2. A picture and/or wall hanging device as in claim 1 wherein the strap comprises a flexible cable.

3. A device as in claim 1 wherein the points of the sliders are mounted centrally on one side of each slider.

4. A picture and/or wall hanging device to mark anchor points level comprising
an elongated flexible strap,
at least one slider disposed on the strap and having a point, and being adjustable to align the anchor hanging point as desired
the point is fixedly adjustable on the strap so as to attain a selected position, and
a level disposed approximately in the middle of the strap to enable adequate leveling of the hanging device.

5. A picture and/or wall hanging device as in claim 4 having two sliders, spaced apart on the strap having points and being adjustable to align the anchor hanging points as desired herein.
